(19) United States
(12) Patent Application Publication
(10) Pub. No.: US 2004/0131258 A1
(43) Pub. Date: Jul. 8, 2004

(54) Method of pattern recognition of computer generated images and its application for protein 2D gel image diagnosis of a disease

(76) Inventors: Myung Ho Kim, East Brunswick, NJ (US); Gene B. Kim, East Brunswick, NJ (US)

Correspondence Address: Bioinformatics Frontier Inc., BioFront, 93 B Taylor Ave, East Brunswick, NJ, 08816, US

(21) Appl. No.: 10/336,334

(22) Filed: Jan. 6, 2003

(51) Int. Cl. G06K 9/62; G06K 9/46

(52) U.S. Cl. 382/224; 382/190

(57) ABSTRACT

The method we invent is about finding patterns of images displayed in computers, generated by such as electrophoresis 2D gel, X-ray and CAT (computer assisted tomography) and applying for a diagnosis of a disease. To get patterns of images, first normalize the images and use knowledge-based machine to classify the set of images into two groups, normal and abnormal. The objective function obtained from the learning machine gives us a criterion to diagnose a disease.

### BACKGROUND OF THE INVENTION

1. Technical Field

The present invention relates to a method that comprises the step of representing an image or a part of it, generated by a computer, as a vector. Moreover, the present invention further comprises the step of applying a machine learning method, such as support vector machine to at least two of such vectors so as to optimally classify the vectors into one of the at least two groups.

The present invention has particular applications, such as a method for diagnosis of a disease by representing a person (or an organism) as the aforementioned vectors and obtaining a cutoff hypersurface by applying the support vector machine to the vectors, wherein the cutoff surface separates and classifies the vectors into the at least two groups, the first with a disease and the second without the disease.

2. Description of the Related Art

The modern diagnosis of a disease heavily relies on images taken from a person, and X-ray, CAT and MRI are common tools for it. However, to distinguish a patient from a normal person is not an easy task. Doctors and biological researchers depend on their experiences of diagnosing a disease by scrutinizing the images with their naked eyes.

The key step is to find certain patterns that distinguish the images of normal people from the images of the patients. To resolve this pattern recognition problem, the present invention introduces a completely new concept for perceiving an image in the emerging area of bioinformatics and applies machine-learning methods to protein 2D gel images for appropriate diagnosis and analysis.

### SUMMARY OF THE INVENTION

The present invention opens up a new horizon for medical diagnosis by introducing a new concept of representing an image, and the invention enhances health care for mankind. It is well known that proteins play crucial roles in metabolism, and any change(s) of a protein may affect functions of a human body. Thus, many researchers are currently trying to find out which proteins and changes are associated with a disease.

Recent developments of computer technologies have enabled many researchers to spot a disease-related protein much easier. However, these tasks are laborious and inefficient. For, it is believed that about several hundred thousands proteins exist, but only a few thousand of them has been able to be studied, despite the intensive researches over the last several decades, and it is rare that a disease is associated with a single protein. What we invent here is not concerned with searching a protein individually, but with finding a pattern of simultaneous changes of multiple proteins that might cause a disease. As in the patent filed, “Method for Diagnosis of a Disease by Using Multiple SNP”(application Ser. No. 10/128,377), we start with two fundamental concepts.

1. In order to classify the objects we are interested in, we need to find a new system of representation of the objects into numbers or vectors.

2. To obtain a criterion (cutoff) for dividing a set into groups, a knowledge-based method (i.e. a machine learning method such as the support vector machine, neural network, decision tree, and others) is needed.

As the strategic concepts above were described, we represent a group of objects, (i.e. a set of computer images) as a set of vectors. Then we label and separate the set into two groups. From the division, we obtain a cutoff/criterion that distinguishes one group from the other group. The cutoff will classify a new vector into a group.

### BRIEF DESCRIPTION OF THE DRAWINGS

The aforementioned aspects and other features of the invention will be explained in the following description, in conjunction with the accompanying drawings wherein:

FIG. 1 is a drawing of an embodiment of the present invention;

FIG. 2 is a drawing of another embodiment of the present invention;

FIG. 3 is a drawing of another embodiment of the present invention;

FIG. 4 is a drawing of another embodiment of the present invention;

FIG. 5 is a drawing of another embodiment of the present invention.

### DETAILED DESCRIPTION

The present invention will be described in detail, with reference to the accompanying drawings. The present invention is based on a new concept and it incorporates machine leaning methods, such as the support vector machine, neural network, decision tree, and many others, with images data generated by a computer.

To apply a machine learning method, such as the support vector machine and neural network, we need to find a way of representing images generated by computers. To this end, it is necessary to understand that any image in the computer is made up of a large number of tiny pixels, each of which is expressed as a number depending on its density and color. On the black and white screen, the number ranges from 0 to 255. Therefore, each image can be expressed as a unique set of numbers, which is a vector in mathematical terms.

Now, suppose we have two sets of images. Let us assume that one set is from normal people and the other set is from the patients. To compare one set with another and find out the difference(s) (i.e. some patterns to distinguish one from another), a careful normalization process is required. The normalization can reduce the inevitable error, the size change of images, caused by routine experiments. To minimize this effect, the method chooses two fixed points as reference points. Then, with respect to the two points, the method expands or reduces the images, by using a mathematical transformation. Finally, the method chooses a rectangular area of the same size from each image.

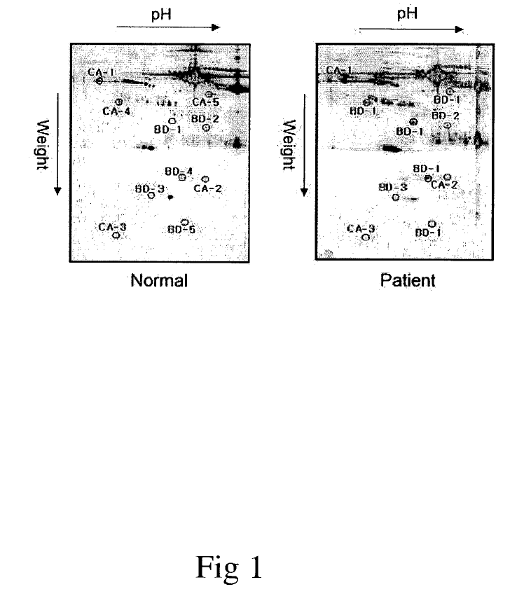

Let us explain in some details for this normalization. FIG. 1 shows a drawing illustrating an embodiment according to the present invention. They are 2D gel images, one from normal person while the other is from a breast cancer patient. Although most of proteins change in quantity depending on each person, some of the proteins are always present, as BD-1 and CA-3 appear in both persons.

1. For two acceptable reference points, it is good to consider two spots representing proteins such as BD-1 in FIG. 1 and pick the center point, i.e. a pixel, from the spot of each image.

2. Once the two reference points, say A and B, are chosen from each image, the method considers coordinate charts on all the images with respect to the number and the position of pixels. Note that the two points are neither on the same horizontal (stretched along pH) nor the same vertical (stretched along weight) line. Thus we have associated coordinates, x and y to each pixel of each image and a transformation function between image 1 and image 2 may be defined as follows:

f:R²→R²

f(A₁)=A₂,f(B₁)=B₂

where {A₁, A₂} and {B₁, B₂} are the two reference points in images 1 & 2. (Consider image 1 is the one from normal and image 2 is the other from patient in FIG. 1.) The simplest function satisfying these conditions is linear, called an Affine transformation. In mathematical terms, f(x)=Mx+b, where M is a 2 by 2 matrix and x and b are in R². The interpolation problem occurs during expansion or reduction, which may be solved by Gauss or linear distribution. Note: We explained the normalization for a pair of two images. Therefore we have to choose an image as the reference and normalize each image with respect to the reference image.

3. Then, the method chooses the area of rectangular form, which is equidistant with respect to the two reference points A and B. The number of pixels in each rectangle should be the same for all images.

4. Thus, each image has the same number of pixels, N, and each of them is associated with a number depending on its color and density. For clarity of explanation and by the nature of claims made, we divide our description into two groups.

Part 1. Claims 1-13:

In these claims, each pixel of a whole rectangular image becomes a component of a vector. By enumerating the whole set of numbers corresponding to each pixel in a predetermined order, we will represent an image as a vector in N dimensional Euclidean space.

Part 2. Claims 14-26:

The point of these claims is to choose some conspicuous spots, which you are interested in looking closely, representing proteins and their quantities. Each of chosen spots has a corresponding number, which is the sum of the numbers assigned to each pixel consisting of the spot. Thus the sum of each spot will represent the relative quantity of the protein corresponding to the spot relative to other spots.

Note that the claim of part 1 is associated with the comparison of the images, themselves, each other while the claim of part 2 is associated with the comparison of some portions of the images. After we represent all the images as vectors in a Euclidean space, as in the patent filed, “Method for Diagnosis of a Disease by Using Multiple SNP” (application Ser. No. 10/128,377), we label the vectors. Depending on whether the person (or the organism) has a specific disease (or a trait) or not, the vector is labeled by +1 or −1 respectively. Each person (or organism) will be represented as a labeled vector accordingly as the existence of a disease (or a trait). Also, at least two of the labeled vectors corresponding to a respective one of a plurality of persons (or organisms) will be classified into one of the at least two different groups, wherein the first one of the at least two groups indicates the presence of the disease (or a trait) and the second one of the at least two groups indicates the absence of the disease (or a trait).

By applying classification methods, such as the support vector machine, we can find a cutoff (criterion) to separate the set of +1 labeled vectors from the set of −1 labeled vectors with optimal errors. More precisely, the cutoff is determined by a hypersurface dividing the Euclidean space into two disjointed sets and will be used for predicting whether a person (or an organism) has a specific disease (or a trait) or not, depending on which set the unlabeled vector representing the person (or the organism) belongs to.

Suppose a cutoff hypersurface separates a Euclidean space into two complementary sets, “I” and “II”. Also, suppose that “I” set contains more +1 labeled vectors than “II”, while “II” set contains more −1 labeled vectors than “I”. We mean optimal errors by maximizing the percentage of the set of +1 labeled vectors in “I” among the total number of labeled vectors of “I” and the rate of the set of −1 labeled vectors in “II” among the total number of labeled vectors of “II”. This is the optimal classification, which we refer to in the claims 11 and 24.

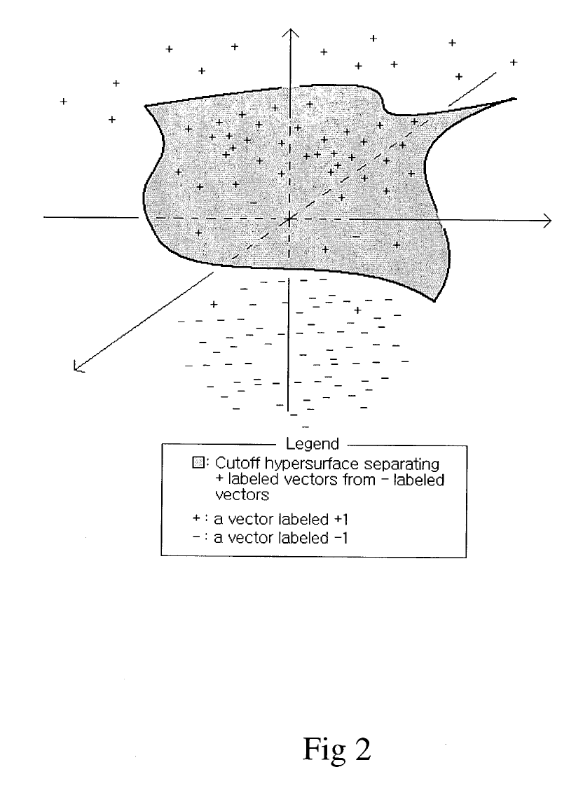

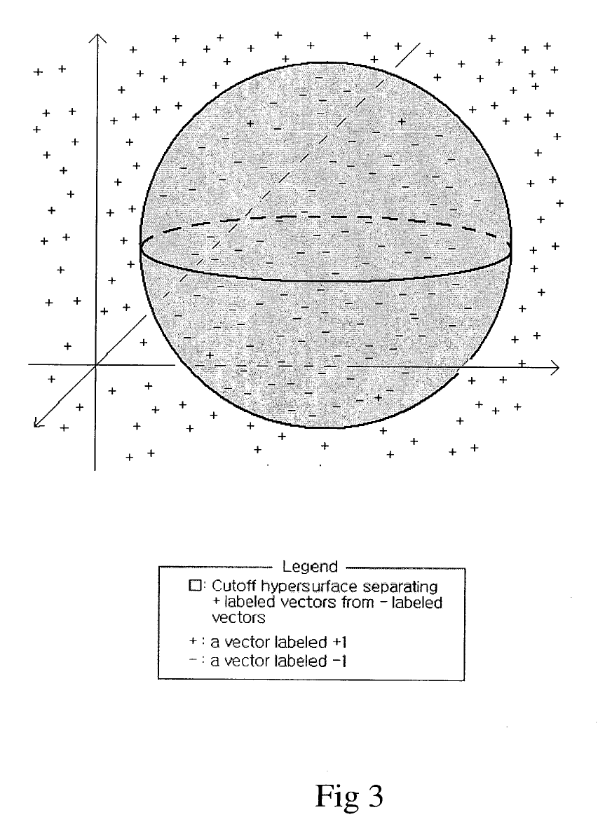

FIG. 2 shows a drawing illustrating an embodiment according to the present invention. FIG. 3 displays an example of a hypersurface (a sphere) separating labeled vectors in the 3-dimensional Euclidean space.

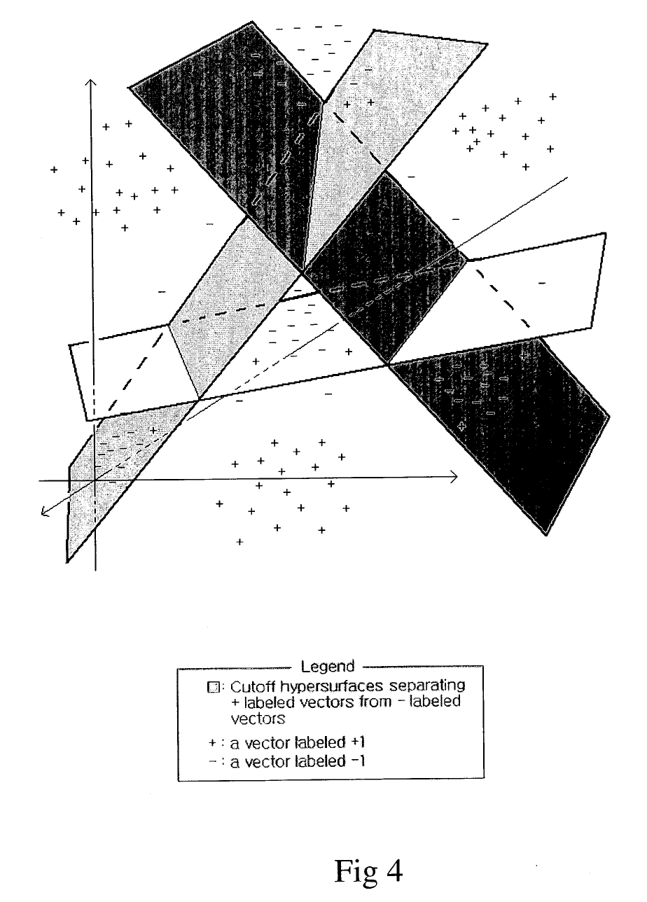

In a method according to FIG. 4, a hyperplane, which is a specific type of a cutoff surface, may be calculated by using an optimization problem comprising the following, wherein each yᵢ is +1 or −1 and xᵢ is a vector:

Maximize:

$$W ( α ) = \frac{1}{2} {\sum }_{i , j = 1}^{l} {y}_{i} {y}_{j} {α}_{i} {α}_{j} ( {x}_{i} \cdot {x}_{j} ) - {\sum }_{i = 1}^{l} {α}_{i}$$

Under the conditions

$${\sum }_{i = 1}^{l} {α}_{i} {y}_{i} = 0 ,$$

and

0≦α₁≦C,i=1, 2 . . . l, wherein C is a given constant

The derivation of the quadratic function W is explained in details in the books, The Nature of Statistical Learning, by Vapnik (Springer Verlag, 1995) and Making large-Scale SVM Learning Practical, by Joachims (Advances in Kernel Methods—Support Vector Learning, MIT Press, 1999).

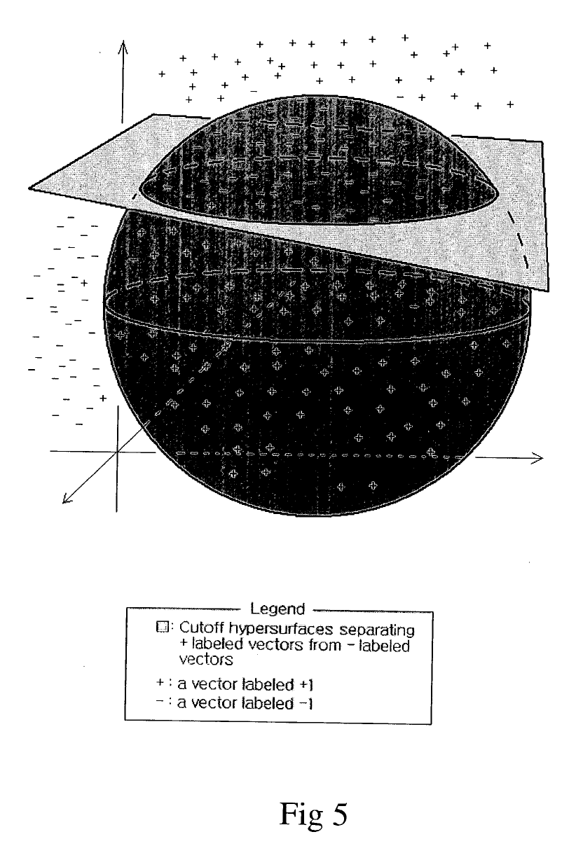

It may be worth noting that this hyperplane may be less accurate than a cutoff hypersurface in classification. In any event, by using either a hyperplane or a general hypersurface, one may be able to predict if a person has the disease by numericalizing the image data for the person and checking to which set the vector belongs to. Moreover, if necessary, in the classifying step, we may, by repeated use of machine learning methods, divide any subset into another two subsets, resulting in two complementary sets of the Euclidean space, of which each set consists of several subsets. In other words, the set, classified as normal or abnormal, need not be connected mathematically. See FIG. 4 and FIG. 5, which show such examples.

Although the preferred embodiments of the present invention have been disclosed for illustrative purposes, those skilled in the art will appreciate that various modifications, additions and substitutions are possible, without departing from the scope and spirit of the invention as disclosed in the appended claims.

1. A method, comprising the following:
representing an image imported to a computer as a vector

2. A method according to claim 1, wherein said image is a collection of a finite number of pixels.

3. A method according to claim 2, wherein each pixel of said image is assigned a number by a computer depending on its color and density.

4. A method according to claim 1, further comprising the following:
normalizing a plurality of images with respect to two distinct pixels by expanding or diminishing images accordingly so that each of said plurality of images should be compared each other.

5. A method according to claim 4, wherein said two pixels are centers of two distinct spots representing two proteins existent commonly in each of said plurality of images and will be used as two reference points for Affine transformations in the two dimensional Euclidean space.

6. A method according to claim 5, wherein each of said Affine transformation is of form Mx+b where M is a matrix, x is a vector and b is a vector in the two dimensional Euclidean space.

7. A method according to claim 5, further comprising the following:
making each of said plurality of images have the same width and height with respect to said two reference points, and the same total number of pixels, denoted by N.

8. A method according to claim 7, wherein said plurality of numbers assigned to each of said same total number of pixels will be enumerated, in a predetermined order, and will form a vector in the N dimensional Euclidean space.

9. A method according to claim 8, wherein said vector corresponds to one of a person and an organism, and wherein said one of a person and an organism belongs in one of at least two different groups of one of a person and an organism, wherein said at least two different groups differ by at least one number corresponding to a pixel of an image.

10. A method according to claim 9, further comprising the following:
representing said one of a person and an organism as one of a labeled vector +1 and a labeled vector −1, wherein said labeled vector +1 indicates a disease and said labeled vector −1 indicates absence of said disease;
classifying at least two of said labeled vectors corresponding to a respective one of a plurality of said one of a person and an organism into either a group with at least two groups, wherein the first one of said at least two groups indicates the disease and the second one of said at least two groups indicates absence of said disease.

11. A method according to claim 10, wherein said classifying step further comprises:
applying a support vector machine to said at least two labeled vectors so as to optimally classify said at least two labeled vectors into one of said at least two groups.

12. A method according to claim 11, further comprising the following:
obtaining a cutoff hypersurface by applying said support vector machine to said at least two vectors, wherein said cutoff hypersurface serves to separate and classify said at least two vectors into said at least two groups.

13. A method according to claim 12, further comprising the following:
calculating a hyperplane by using an optimization problem comprising the following, wherein each yᵢ is +1 or −1 and xᵢ is a vector:
Maximize:
$$W ( α ) = \frac{1}{2} {\sum }_{i , j = 1}^{l} {y}_{i} {y}_{j} {α}_{i} {α}_{j} ( {x}_{i} \cdot {x}_{j} ) - {\sum }_{i = 1}^{l} {α}_{i}$$
Under the conditions
$${\sum }_{i = 1}^{l} {α}_{i} {y}_{i} = 0 ,$$
and 0≦αᵢ≦C, i=1, 2 . . . l, wherein C is a given constant

14. A method, comprising the following:
representing a spot in an image generated by a computer as a number.

15. A method according to claim 14, wherein said spot is a collection of a finite number of pixels and represent a protein.

16. A method according to claim 15, wherein each spot of said image is assigned a number by summing up numbers associated to each pixel of said spot, depending on its color and density, and the number represents the relative quantity of a protein corresponding to said spot.

17. A method according to claim 14, further comprising the following:
normalizing a plurality of images with respect to two distinct pixels by expanding or diminishing images accordingly so that each of said plurality of images should be compared each other.

18. A method according to claim 17, wherein said two pixels are centers of two distinct spots representing two proteins existent commonly in each of said plurality of images and will be used as two reference points for Affine transformations in the two dimensional Euclidean space.

19. A method according to claim 18, wherein each of said Affine transformations is of form Mx+b where M is a matrix, x is a vector and b is a vector in the two dimensional Euclidean space.

20. A method according to claim 18, further comprising the following:
making each of said plurality of images have the same width and height with respect to said two reference points, and the same total number of pixels.

21. A method according to claim 14, wherein said plurality of numbers assigned to each of said spots in a image will be enumerated, in a predetermined order, and will form a vector in the finite, say L, dimensional Euclidean space, depending on the number of spots to be dealt.

22. A method according to claim 21, wherein said vector corresponds to one of a person and an organism, and wherein said one of a person and an organism belongs in one of at least two different groups of one of a person and an organism, wherein said at least two different groups differ by at least one number corresponding to a pixel of an image.

23. A method according to claim 22, further comprising the following:
representing said one of a person and an organism as one of a labeled vector +1 and a labeled vector −1, wherein said labeled vector +1 indicates a disease and said labeled vector −1 indicates absence of said disease;
classifying at least two of said labeled vectors corresponding to a respective one of a plurality of said one of a person and an organism into either a group with at least two groups, wherein the first one of said at least two groups indicates the disease and the second one of said at least two groups indicates absence of said disease.

24. A method according to claim 23, wherein said classifying step further comprises:
applying a support vector machine to said at least two labeled vectors so as to optimally classify said at least two labeled vectors into one of said at least two groups.

25. A method according to claim 24, further comprising the following:
obtaining a cutoff hypersurface by applying said support vector machine to said at least two vectors, wherein said cutoff hypersurface serves to separate and classify said at least two vectors into said at least two groups.

26. A method according to claim 25, further comprising the following:
calculating a hyperplane by using an optimization problem comprising the following, wherein each yᵢ is +1 or −1 and xᵢ is a vector:
Maximize:
$$W ( α ) = \frac{1}{2} {\sum }_{i , j = 1}^{l} {y}_{i} {y}_{j} {α}_{i} {α}_{j} ( {x}_{i} \cdot {x}_{j} ) - {\sum }_{i = 1}^{l} {α}_{i}$$
Under the conditions
$${\sum }_{i = 1}^{l} {α}_{i} {y}_{i} = 0 ,$$
and 0≦αᵢ≦C,i=1, 2 . . . l, wherein C is a given constant
